(19) United States
(12) Patent Application Publication
(10) Pub. No.: US 2005/0190132 A1
(43) Pub. Date: Sep. 1, 2005

(54) System for driving rows of a liquid crystal display

(76) Inventors: Francesco Pulvirenti, Acireale (IT); Salvatore Privitera, Catania (IT); Leonardo Sala, Pont Saint Martin (IT); Salvatore Pappalardo, Catania (IT)

Correspondence Address: HOGAN & HARTSON LLP, ONE TABOR CENTER, SUITE 1500, 1200 SEVENTEENTH ST, DENVER, CO, 80202, US

(21) Appl. No.: 10/518,608

(22) PCT Filed: Jun. 23, 2003
(86) PCT No.: PCT/EP03/06639

§ 371 Date: Dec. 23, 2004

(30) Foreign Application Priority Data
Jun. 27, 2002 (IT) MI2002A001426

(51) Int. Cl. G09G 3/36

(52) U.S. Cl. 345/87

(57) ABSTRACT

The present invention describes a system for driving rows of a liquid crystal display including at least one module for driving one single row of the liquid crystal display. The module includes an inverter operating in a supply path between a first and a second supply line of the system, where the first supply line includes a first switch for coupling the inverter to a first or to a second supply voltage and the second supply line includes a second switch for coupling the inverter to a third or to a fourth supply voltage. The inverter is driven by logic circuitry and provides a drive signal for one single row of the liquid crystal display.

### FIELD OF THE INVENTION

The present invention refers to a system for driving rows of a liquid crystal display.

### BACKGROUND OF THE INVENTION

Liquid crystal displays (LCD) are used today in an ever-increasing number of products such as cellular telephones, portable computers, etc. The displays, which can be in black and white, or in a grey or colors scale, are usually made up of a matrix of electrodes in rows and columns driven by the application of an appropriate voltage signal, a change in the optic behavior of the liquid crystal placed between them occurs at the crossing points (“the pixels”).

The image that is visualized on the display is obtained through different possible methods for driving the rows and the columns.

One method that is often used for driving an LCD and known as Improved Alt & Pleshko (IA&P) requires a single row electrode to be excited for an elementary period of time by a single spurt tone and the simultaneous excitation of the column electrodes; to the latter are then applied voltage values suitable for determining the powering up or the powering down of all the pixels that belong to that single row. For a successive period of elementary time there is an excitation of another row electrode and so on until the scanning of the last row electrode is completed; therefore if the row electrodes are a number N and T is the period of elementary time, the time needed for scanning all the rows is given by NT which is also called a “frame”.

The optic transmission characteristics of the liquid crystal vary with the amplitude of the voltage applied to the relative pixel, but the application of direct voltage is damaging for the liquid crystal as it permanently changes and degrades the physical properties of the material. For this reason the voltage signals used to drive the single pixels of an LCD are alternating voltage signals in relation to a common value of direct voltage that not necessarily has to be ground potential. In this manner the driving of a pixel of the display comes about through two waveforms of equal amplitude but with opposite polarity in relation to a common voltage, which follow each other periodically. Therefore the driving voltage applied to a given pixel during its period T within a frame is applied with opposite polarity during the respective period T of the successive frame.

Nevertheless all these voltage transitions involve a significant power that has to be managed by the drive circuits. Therefore one of the primary purposes in planning the driving devices of LCD rows and columns is to reduce the power consumption so as to minimize both the power delivered by the power supplies of said devices, and the power dissipated by them.

One part of a driving device of LCD rows and columns, more precisely the Philips PCF8548 device, is described in FIG. 1.

The LOW_FRAME signal is a logic signal that equals zero in the even frames, and equals one in the uneven frames. ROW_ON is a logic signal that equals zero when the row in question is not selected, equalling one when it is being scanned. Starting from these two signals, through a circuit 1, the control signals that drive two PMOS transistors T9, T10 and two NMOS transistors T7, T8 are generated. In particular the gate terminals of the transistors T8, T9 are T10 are driven through three identical circuit cells C1, shown in FIG. 2. Said cells are level-shifters, that is, buffers that convert the logic signal levels from low voltage to high voltage, in particular, from the supply voltage VDD to a driving voltage VLCD generated by a device (not shown in the Figure) comprising a booster regulator through the connection of a certain number of stages of a charge pump.

Each cell C1 comprises two NMOS transistors M22 and M23 driven by signals A and NA, the output signal of the logic circuitry 1 and the negative signal A. The source terminals of the transistors M22 and M23 are connected to the voltage VSS and the drain terminals are connected respectively to the drain terminals of two PMOS transistors M20 and M21 on the source terminal of which the voltage VLCD is present; in addition, the drain terminals of transistors M22 and M23 are connected to the gate terminals of the transistors M21 and M20. The outputs Q drive the gate of transistors T10, T9 and T8.

The gate terminal of transistor T7 is instead driven directly by a logic low voltage signal.

The source terminal of transistor T9 is connected to a voltage reference VA while the drain terminal is connected to the drain terminal of transistor T10 whose source terminal is connected to the voltage VLCD. The source terminal of transistor T8 is connected to a voltage reference VB while the drain terminal is connected to the drain terminal of transistor T7 whose source terminal is connected to the voltage VSS. The drain terminals of the pairs of transistor T7-T8 and T9-T10 are in common and supply the output signal OUT.

The voltages VA and VB are different levels of intermediate voltages between the voltages VLCD and VSS that are generated inside the drive device of an LCD. The ratio between these levels and VLCD is chosen on the basis of the dimension of the matrix of the display according to the criteria that is shown below.

In particular, according to the technique of Improved Alt & Pleshko, to drive the liquid crystal display adequately, four different levels of intermediate voltage between VLCD and VSS are generated inside the device. The relation between these voltages and VLCD is set on the basis of the number of rows m of the display according to the relations:
VLCD, [(n+3)/(n+4)]*VLCD, [(n+2)/(n+4)]*VLCD, [2/(n+4)]*VLCD, [1/(n+4)]*VLCD, VSS)
with n=\sqrt{m}−3

If, for example, m=81=>n=6 in the case of a display with 81 rows the voltage levels will be:
VLCD (9/10)*VLCD (8/10)*VLCD (2/10)*VLCD (1/10)*VLCD VSS.

With reference to the drive circuit of FIG. 1, in the case of a drive of rows, the voltage references VA and VB equal respectively to (9/10)*VLCD and (1/10)*VLCD. The drive operates in the following manner: in a frame transistors T9 and T7 are turned on alternately while transistors T10 and T8 are off; in this case the output signal OUT, suitable for driving a row, varies between VSS and VA according to whether the row is being scanned or not. In the successive frame, transistors T10 and T8 are turned on alternately while transistors T9 and T7 are off and therefore the output signal will vary between VLCD and VB according to whether the row is being scanned or not. The waveforms of the output signal OUT in the case of driving two rows ROW0 and ROW1 for a frame n and for the successive frame n+1 are shown in FIG. 3. The FIG. 4 shows the image as it appears on the display.

### SUMMARY OF THE INVENTION

According to an embodiment of the present invention a system for driving rows of a liquid crystal display has a minor number of components in comparison to known systems and therefore occupies a smaller overall area in the integration of the system.

In accordance with an embodiment of the present invention, a system for driving rows of a liquid crystal display includes at least one module for driving a single row of said liquid crystal display, said module including an inverter operating in a supply path between a first and a second supply line of said system, said first supply line including first means capable of connecting it to a first or to a second supply voltage and said second supply line including second means capable of connecting it to a third or to a fourth supply voltage, said inverter being driven by a logic circuitry and sending in output a driving signal for a single row of said liquid crystal display.

### BRIEF DESCRIPTION OF THE DRAWINGS

The characteristics and the advantages of the present invention are evident from the following detailed description of an embodiment thereof illustrated as non-limiting example in the enclosed drawings, in which:

FIG. 1 is a circuitry diagram of a row driving device of an LCD according to the known art;

FIG. 2 is a more detailed circuitry diagram of a part of the circuit of FIG. 1;

FIG. 3 shows waveforms of the output voltage signal of the circuit of FIG. 1 in the case of driving two rows;

FIG. 4 shows an image formed on the display of an LCD;

FIG. 5 is a circuitry diagram of a system for driving the rows of an LCD according to an embodiment of the invention;

FIG. 6 shows the time waveforms LOW_FRAME, ROW_ON and OUT of the device of FIG. 5.

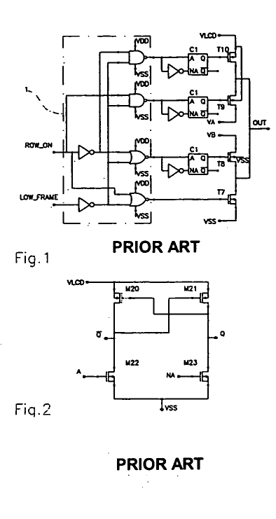

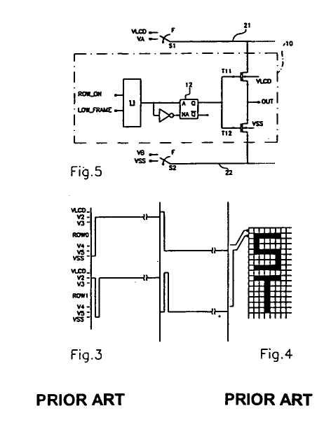

### DETAILED DESCRIPTION OF THE PREFERRED EMBODIMENTS

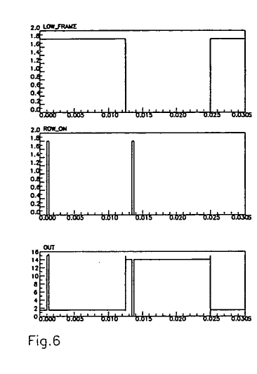

With reference to FIG. 5 a circuit diagram of a system for driving rows of an LCD according to the present invention is shown. Said system uses various drive modules 10, one for each row of the display. Each module comprises low voltage logic circuitry 11 coupled to a level-shifter device 12 that drives a PMOS transistor T11 and a NMOS transistor T12 forming an inverter and having a single output terminal OUT where the signal for driving a single row is present. Transistors T11 and T12 are coupled to two supply lines 21 and 22 that can be connected to two different supply voltages, respectively VLCD, VA and VB, VSS, through two selector switches S1 and S2 controlled by a signal F, which is a function of the signal LOW_FRAME. Said signal F causes the switching of switch S1 on VA and of switch S2 on VSS if the signal LOW_FRAME is at logic level zero, while it causes the commutation of switch S1 on VLCD and of switch S2 on VB if the signal LOW_FRAME is at the logic level one.

Circuitry 11, which is preferably made up of only one XOR gate, operates in a supply path between the supply voltages VDD and VSS and in input has the two logic signals LOW_FRAME and ROW_ON, in which the logic signal LOW_FRAME is a logic signal that is equal to zero in the even frames, and is equal to one in the uneven frames while the logic signal ROW_ON is equal to zero when the row in question is not selected, and is equal to one when being scanned.

The output signal A has the value of voltages VDD and VSS and together with the signal NA, that is the negative signal A, drives the elevator device or level-shifter 12 that operates between the supply voltages VLCD and VSS and has a similar circuit structure to the cell C1 of FIG. 2. The output signal Q of the device 12 drives the gate of the two transistors T11 and T12.

If in an even generic frame n (the signal LOW_FRAME=0), if the row selected is being scanned (the signal ROW_ON=1), the output signal of the device 12 has the value of the voltage VLCD and the output signal OUT has the value of the voltage VSS. If instead the row selected is not being scanned (the signal ROW_ON=0), the output signal of the device 12 has the value of the voltage VSS and the output signal OUT has the value of the voltage VA.

At the successive frame n+1 (the signal LOW_FRAME=1), if the row selected is being scanned (the signal ROW_ON=1), the output signal of the device 12 has the value of the voltage VSS and the output signal OUT has the value of the voltage VLCD. If instead the row selected is not being scanned (the signal ROW_ON=0), the output signal of the device 12 has the value of the voltage VLCD and the output signal OUT has the value of the voltage VB.

In the FIG. 6 the time waveforms of the signals LOW_FRAME, ROW_ON and OUT are shown in two successive frames, that is for an even frame and for an uneven frame.

1. A system for driving rows of a liquid crystal display comprising:
at least one module for driving one single row of said liquid crystal display, said module comprising an inverter operating in a supply path between a first and a second supply line of said system, said first supply line comprising first means capable of coupling it to a first or to a second supply voltage and said second supply line comprising second means capable of coupling it to a third or to a fourth supply voltage, said inverter being driven by logic circuitry and providing a drive signal for one single row of said liquid crystal display.

2. The system according to claim 1, wherein said inverter comprises a PMOS transistor and a NMOS transistor.

3. The system according to claim 1, wherein the value of said first supply voltage exceeds said second supply voltage, the value of said second supply voltage exceeds said third supply voltage, and the value of said third supply voltage exceeds said fourth supply voltage.

4. The system according to claim 1, wherein said first and second means are controlled by a logic signal that controls respectively the connection of the first supply line to said first or to said second supply voltage and the connection of the second supply line to said third or to said fourth supply voltage according to whether a frame is uneven or even.

5. The system according to claim 4, wherein said logic circuitry comprises a logic device capable of supplying an additional input logic signal to an elevator device capable of raising the level of said additional logic signal for driving said inverter.

6. A module for driving a row in a liquid crystal display comprising:
an inverter having first and second power terminals;
a first switch for coupling the first power terminal of the inverter to a first or a second supply voltage; and
a second switch for coupling the second power terminal of the inverter to a third or fourth supply voltage, wherein the inverter is driven by a logic circuit and provides a drive signal for the row.

7. The module of claim 6, wherein the inverter comprises a PMOS transistor and a NMOS transistor.

8. The module of claim 6, wherein the first and second supply voltages have different values, and the third and fourth supply voltages have different values.

9. The module of claim 6, wherein the first and second switches are driven by a logic signal, the state of the logic signal being determined by whether a frame is uneven or even.

10. The module of claim 9, further comprising a level shifter.
